(19) United States
(12) Patent Application Publication
(10) Pub. No.: US 2019/0180651 A1
(43) Pub. Date: Jun. 13, 2019

(54) Advertising Tape and Method Thereof

(71) Applicant: Blair Holland, Chester, NJ (US)

(72) Inventor: Blair Holland, Chester, NJ (US)

(21) Appl. No.: 16/214,503

(22) Filed: Dec. 10, 2018

Related U.S. Application Data
(60) Provisional application No. 62/708,494, filed on Dec. 11, 2017.

(51) Int. Cl. G09F 3/10

(52) U.S. Cl. CPC G09F 3/10; B65D 63/1009

(57) ABSTRACT

The present invention discloses a tape for packaging that includes removable labels consisting of multiple layers of media and a method for production of a continuous tape including a process for strategic placement of the labels along the tape.

### CROSS-REFERENCE TO RELATED APPLICATIONS

The present application is related to, claims the earliest available effective filing date(s) from (e.g., claims earliest available priority dates for other than provisional patent applications; claims benefits under 35 USC § 119(e) for provisional patent applications), and incorporates by reference in its entirety all subject matter of the following listed application(s) (the “Related Applications”) to the extent such subject, matter is not inconsistent herewith; the present application also claims the earliest, available effective filing date(s) from, and also incorporates by reference in its entirety all subject matter of any and all parent, grandparent, great-grandparent, etc. applications of the Related Application(s) to the extent such subject matter is not inconsistent herewith:

U.S. provisional patent application 62/708,494 entitled “Removable Branding Label and Adhesive Tape. Combination and Method.”, naming Blair Holland as inventor, filed 11 Dec. 2017.

### BACKGROUND

### 1. Field of Use

The present invention, relates to adhesive tapes having removable brand labels disposed thereon. The present invention also relates to methods of advertisement with a customer who ordered a product or service, methods of recording information on at least two items, and methods of making an advertising tape for packaging for an ordered product or service.

### 2. Description of Prior Art

Companys often spend a considerable amount of resources developing brand recognition in the consuming public. Successful brand development allows the consumer to differentiate between goods and/or services provided by various sources.

Successful development of a brand is only part of an effective marketing strategy. Brand, visibility, especially amongst the target demographic, is also necessary to reinforce brand recognition and facilitate brand recall in the minds of potential customers.

Stickers are often used as a vehicle to present the brand to the public. Branded stickers are ornamental and typically serve no other function but to display the brand. Although the company has a vested interest in the display of the brand, few others may share such a compelling interest. Therefore, the primarily ornamental functions of stickers limit the perpetuation of the brand by failing to provide sufficient incentive for consumers to acquire the stickers and subsequently display the brand label.

Over the years, manufacturers and retailers have used, many methods to entice consumers to purchase products offered in the market. One such method involves the art of using premiums.

Premiums offer the consumer the opportunity to receive materials of value generally associated with the purchase of a product. Typically, the materials of value include coupons, sweepstakes, mail-in rebates or other items such as inexpensive toys. The materials of value are often concealed from the immediate sight of the consumer as part of the lure to get the consumer to purchase the product. For instance, it is known in the art that cereal manufacturers will hide inexpensive toys or games inside a box of cereal as a means to encourage young children to choose a particular brand of cereal over another. Usually associated with the inexpensive toys or games hidden in the box of cereal is some form of printed advertisement to alert the young children or the adult that a material of value is contained inside and available after the point of purchase.

Premiums have become well known in the art as “incentives” to induce sales. Recently, premiums have taken on different forms from the traditional coupons, sweepstakes, or mail-in rebates. Today, telephone calling cards, debit cards, and now smart cards are available as premiums that offer free telephone use or credit as a material of value to entice consumers normally more mature purchasers), to buy a product. More and more, these new forms of premiums are being offered by manufacturers and retailers as incentives to increase the sale of products.

The delivery of the premiums to the consumers is also an art. Packaging labels to deliver premiums to consumers in order to generate sales is a practice frequently used by many manufacturers and retailers. Typically, premiums such as coupons, mail-in rebates, sweepstakes entry forms, product literature, or related product information have been delivered to consumers in multi-panel labels or expanded content labels affixed to a container. U.S. Pat. Nos. 3,250,385, 3,436,854, 3,525,470, 3,943,645, and 4,103,821 disclose examples of such labels. Collectively, these patents disclose the use of an adhesive envelope or package to affix to a container and having a transparent cover sheet for containing, mounting, and protecting display material such as advertising sheets, packaging slips, advertising posters, and data cards.

It is an object of the present invention to provide a removable sticker or brand coupon/label that is integrated onto conventional tape products used in the packaging, construction, and automotive industries. The widespread use of such tapes will promote the increased distribution of brand coupons and advertising labels.

### BRIEF DESCRIPTION OF THE DRAWINGS

The foregoing and other objects, features, and advantages of the invention are apparent from the following detailed description taken in conjunction with the accompanying drawings in which:

FIG. illustrates the label 5 of the present invention affixed to an adhesive tape 10;

FIG. 2 illustrates a cross section of the layers that comprise the advertising tape of the present invention, the layers separated by a space for illustrative purposes;

FIG. 3 illustrates a brand label 5 as applied to a continuous strip of adhesive tape 10;

FIG. 4 illustrates the affixed label of FIG. 1 after it is partially pulled off the tape 10 showing text on the backside of the label 5 as well as on the surface of tape 10.

### SUMMARY OF THE INVENTION

The present invention comprises the integration of a removable advertising label having, multiple layers of advertising information with a packaging tape. The advertising label includes multiple layers of incentive items that would appear on the packaging of a recently purchased consumer item. It is contemplated a process for affixing the removable labels to a packaging tape that contains specific information pertinent to a manufacturer or the like. The removable labels may include incentive offers, etc, from the product manufacturer. Advertising both on the packaging tape and on the removable label provide an enhanced advertising, scenario.

### DETAILED DESCRIPTION

In the following description, the same numerical references refer to similar elements. The embodiments, geometrical configurations, materials mentioned and/or dimensions shown in the figures or described in the present description are preferred embodiments only, given for exemplification purposes only.

In the context of the present invention, any equivalent expression, and/or compound words thereof known in the art will be used interchangeably, as apparent to a person, skilled in the art.

Furthermore, the order of the steps of the method described herein should not be taken as to limit the scope of the invention, as the sequence of the steps may vary in a number of ways, without affecting the scope or working of the invention, as can also be understood.

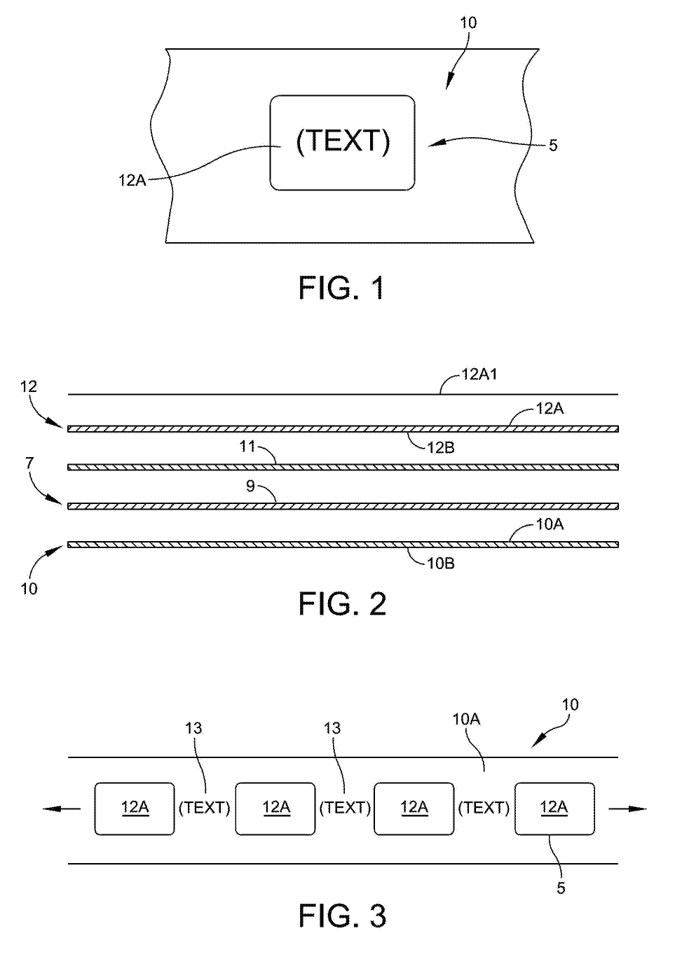

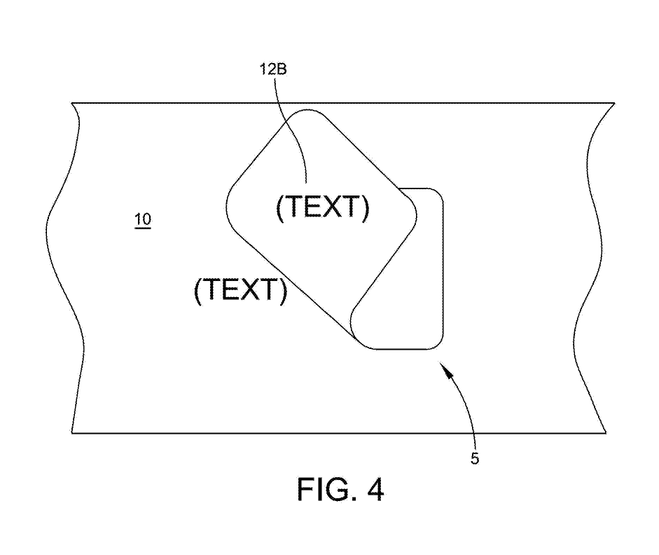

Referring to FIG. 1, removable label 5 is illustrated as attached to a tape material 10. In various embodiments, the tape material 10 may be a fabric-based, paper-based, film based or composite based tape with structural and/or adhesive properties adapted for any number of a wide variety of applications. FIG. 2 illustrates a cross-section of tape 10 (Ref 10A, 10B) with label 5 (Ref 7, 9, 11, 12B, 12A) attached thereto. In the preferred embodiment, the tape material 10 includes a tape 10 including an adhesive component 10B that is activated by exposure to water and a top surface 10A. The tape material is not limited to tapes activated by water and may include any type tape known in the art. The labeling process described herein is also applicable to the application of the labels to any medium that requires the labels to be spaced sequentially along a surface.

Removable label 5 includes a permanent adhesive 7 that is bonded to top layer 10A of label 5 and includes a perimeter defined by the perimeter of label 5. Since adhesive component 10B is activated by exposure to water, the tape material 10 including removable labels 5 can be packaged in rolls without the possibility of the labels being removed from the tape when the rolls are unwound.

Label 5 further includes a thin, translucent polypropylene film layer 9 bonded to permanent adhesive 7 and may include printing thereon. The film layer 9 remains bonded to adhesive 7 when the label 5 is removed or peeled from the tape 10. Adhesive layer 11 is a temporary adhesive that secures the printed portion 12 of the label 5 to the polypropylene film layer 9. Printed portion 12 can effectively be removed from temporary adhesive 11. Printed portion 12 includes a top and a bottom surface 12A and 12B. Surface 12A may include an advertisement and instructions to remove printed portion 12 to reveal additional information printed on bottom surface 12B. Surface 12A may also include a release coating 12A1 to ensure that the peelable label is not removed from the top surface of the tape when unwound from the tape roll during normal use.

As illustrated in FIG. 3, a plurality of labels 5 is contemplated in the present invention as positioned along the length of tape 10 top surface 10A. The labels may take on any geometric shape and may be removed after the tape 10 is used for its intended purpose. For example, where the tape is used in the packaging of products for retail sale and shipping, the end used will receive the package and be prompted to remove the peelable labels at any point along the length of the tape 10. FIG. 3 illustrates a peelable label 5 as applied to tape 10.

To produce the labels 5 of the present invention a process known in the art, flexographic printing, may be employed. In one embodiment, the label stock used is a polypropylene having a thickness of 2 mil. The process implements the label structure described above by bonding a first polypropylene portion 12 of the label to a second polypropylene film layer 9 via a temporary adhesive 11.

The labels may be manufactured via a multi-stage printing press known in the art that implements the flexographic printing process known in the art. First, a reverse image is placed on the bottom surface 12B of the first polypropylene printed portion 12 to serve as the “hidden message” revealed only after the first polypropylene portion 12 is removed or peeled away from second polypropylene film layer 9. The “hidden message” portion may utilize a background color that is distinct from the message color in a variety of color combinations to make the message appealable to the end user. Printed portion 12 top surface 12A includes the text to prompt the user to peel the label to reveal the hidden message, and can include the company's logo and multiple color schemes to draw attention to the label. Although described as an advertising tool the text present on top surface 12A and bottom surface 12B is not limited to advertising and can include any text for any purpose.

The coupons are finally cut utilizing a die cutting process or label cutting station where the final dimension of the labels are realized. The labels are manufactured by a process known in the art and are rolled onto a release liner to be used in the next step of applying the labels 5 to a tape material 10.

The labels are applied to the surface of the adhesive tape by any method known in the art such as utilizing pressure sensitive labeling equipment. The labeling equipment removes a release liner (not shown) and applies the labels 5 to a tape material 10. In the present invention, the labels may be applied to the tape in between the pre-printed text portions 13 as illustrated in FIG. 3, or alternatively, where the tape 10 may comprise preprinted continuous text, the labeling equipment can be set to identify a marking on the tape 10 as a point to apply the labels 5 or apply the labels 5 based on set distances between each label 5.

Any type of label applicator may be used, such as a label applicator that feeds labels from a reel or from a fan-fold supply of labels 5. Multiple reels may be utilized in series in order to allow for continuous operation when a reel runs out of labels. Alternatively, accordion, or fan-folded pleated labels positioned in trays or boxes may be utilized instead of a reel. The release liner of label 5 should have sufficient strength to withstand the application process to permit disposal of the release liner.

The label applicator should include a photo eye or similar technology known in the art that is linked to a computerized mechanism to control the application of the labels to the tape. The label applicator includes the capabilities to sense the gaps or spaces between pre-printed text portions along tape 5 and to thereafter apply the labels between the text. Any type of known sensor may be utilized for this purpose.

The embodiments shown of the present invention are intended to be merely exemplary and those skilled in the art shall be able to make numerous variations and modifications to it without departing from the spirit of the present invention. All such variations and modifications are intended to be within the scope of the present invention as defined in the appended claims.

I Claim:

1. A tape comprising:
A first layer having a first surface and a second surface;
an adhesive coupled to said second surface;
a plurality of brand labels secured along said first layer first surface;
said brand labels released from said first layer first surface when peeled from said first layer.

2. A tape according to claim 1,
wherein said brand label further includes a first layer and a second layer, said second layer having a top and bottom surface, said bottom surface of said second layer permanently bonded to said first layer first surface of said tape;
said brand label first layer releasable from said brand label second layer.

3. A tape according to claim 1,
wherein said tape first layer first surface further includes a plurality of preprinted text sections positioned sequentially along said tape, said plurality of preprinted text sections including a plurality of spaces therebetween, and
wherein said plurality of brand labels are secured at said plurality of spaces.

4. A tape according to claim 3,
wherein said brand label further includes a first layer and a second layer, said second layer having a top and bottom surface, said bottom surface of said second layer permanently bonded to said first layer first surface of said tape;
said brand label first layer releasable from said brand label second layer.

5. A tape according to claim 1, wherein said adhesive is activated upon being exposed to water.

6. A tape according to claim 4, wherein said bottom surface of said second layer layer of said brand label further includes preprinted text, and wherein said brand label first layer further includes a top and bottom surface, said top and bottom surface further including preprinted text.

7. A method of producing an advertising tape, comprising the steps of:
feeding a packaging tape in a first direction;
printing a plurality of preprinted text sections sequentially along said tape, said plurality of preprinted text sections including a plurality of spaces therebetween;
detecting said plurality of spaces along said tape;
applying a plurality of removable brand labels over said plurality of detected spaces.

8. The method of claim 7 wherein said plurality of removable brand labels are released from said advertising tape when peeled therefrom.

9. The method of claim 8, wherein said released brand label includes a top and bottom surface, said top and bottom surface including preprinted text.

10. The method of claim 8, wherein said removed brand labels reveal preprinted text in said plurality of spaces along said tape.

11. A tape according to claim 1,
wherein said tape first layer first surface further includes preprinted text sections positioned along said tape, and wherein said plurality of brand labels are secured at spaced intervals along said tape.

12. A tape according to claim 11,
wherein said brand label further includes a first layer and a second layer, said second layer having a top and bottom surface, said bottom surface of said second layer permanently bonded to said first layer first surface of said tape;
said brand label first layer releasable from said brand label second layer.

13. A tape according to claim 12, wherein said bottom surface of said second layer layer of said brand label further includes preprinted text, and wherein said brand label first layer further includes a top and bottom surface, said top and bottom surface further including preprinted text.

14. A method of producing an advertising tape, comprising the steps of:
feeding a packaging tape in a first direction, the packaging tape including preprinted text portions;
applying a plurality of removable brand, labels over said preprinted text portions.

15. The method of claim 14, wherein said plurality of removable brand labels are released from said advertising tape when peeled therefrom.

16. The method of claim 14, wherein said released brand label includes a top and bottom surface, said top and bottom surface including preprinted text.

17. The method of claim 14, wherein said removed brand labels reveal preprinted text in said plurality of spaces along said tape.

18. The method as in claim 14, wherein said step of applying a plurality of removable brand labels over said preprinted text portions further includes the step of applying the brand labels to said tape at set distances between each of said labels.

19. The method as in claim 14, wherein said preprinted text portions further include a plurality of markers along said packaging tape.

20. The method as in claim 19, wherein the step of applying a plurality of removable brand labels over said preprinted text portions further includes the step of applying the brand labels to said tape at said marker positions.
